(19) United States
(12) Patent Application Publication
(10) Pub. No.: US 2014/0265826 A1
(43) Pub. Date: Sep. 18, 2014

(54) Asymmetrical Slow Wave Structures to Eliminate Backward Wave Oscillations in Wideband Traveling Wave Tubes

(71) Applicant: Teledyne Wireless, LLC, Thousand Oaks, CA (US)

(72) Inventors: Yehuda G. Goren, Scotts Valley, CA (US); Tong Chen, Palo Alto, CA (US)

(21) Appl. No.: 13/799,953

(22) Filed: Mar. 13, 2013

(51) Int. Cl. H01J 23/26

(52) U.S. Cl. CPC H01J 23/26
USPC 315/3.5

(57) ABSTRACT

In various embodiments, a traveling wave amplifier circuit is disclosed. The traveling wave amplifier circuit is configured to receive an RF wave and an electron beam. The traveling wave amplifier effects synchronized interaction between the RF wave and the electron beam. The traveling wave amplifier circuit comprises a waveguide. The waveguide comprises a plurality of asymmetric cells arranged periodically. The waveguide is configured to receive an electron beam. Each of the asymmetric cells comprises at least one asymmetrical structure within the asymmetric cell to modify the dispersion relation of the waveguide.

### BACKGROUND

Backward-wave oscillation in traveling wave-tube amplifiers has been a problem since the development of traveling wave tubes in the 1940s. Traveling wave-tube amplifiers are configured to affect interaction between an input radio frequency (RF) wave and an input electron beam. Backward wave oscillation occurs when a reflected RF wave traveling towards the input interacts with the electron beam. The backward wave is amplified and causes oscillation of the traveling wave-tube amplifier. Backward-wave oscillation limits the operational bandwidth of traveling wave-tube amplifiers to a fraction of the theoretical bandwidth as well as its output power.

Various solutions have been attempted to limit the backward-wave oscillation of traveling wave amplifiers. For example, attenuation sections may be added to the traveling wave-tube amplifier to cause attenuation of the backward wave. However, this attenuation also affects the forward wave, and therefore the length of the traveling wave-tube amplifier circuit must be increased to compensate. The lengthening of the traveling wave-tube amplifier creates further backward wave oscillation. Also, from thermal considerations, the attenuations are limited to the traveling wave-tube gain sections and not to the power output section. The existing techniques for limiting backward-wave oscillation still result in loss of bandwidth and provide less efficiency as the power of the input wave is increased.

### SUMMARY

In various embodiments, a traveling wave amplifier circuit is disclosed. The traveling wave amplifier circuit is configured to receive an RF wave and an electron beam. The traveling wave amplifier effects synchronized interaction between the RF wave and the electron beam. The traveling wave amplifier circuit comprises a waveguide. The waveguide comprises a plurality of asymmetric cells arranged periodically. The waveguide is configured to receive an electron beam. The waveguide affects interaction between the RF input way and the electron beam. Each of the asymmetric cells comprises at least one asymmetrical structure within the asymmetric cell to modify the dispersion relation of the waveguide.

In various embodiments, a traveling wave tube amplifier is disclosed. The traveling wave tube amplifier comprises a waveguide. The waveguide comprises a plurality of asymmetric cells arranged periodically. The waveguide is configured to receive an electron beam. Each asymmetric cell comprises at least one asymmetrical structure within the asymmetric cell to modify the dispersion relation of the waveguide. The modified dispersion relation prevents backward-wave oscillation in the waveguide. The traveling wave tube amplifier further comprises an electron beam input device configured to generate the electron beam in the waveguide. The waveguide is configured to slow a wave velocity of an input radiofrequency beam to match an input velocity of the electron beam.

### DRAWINGS

The features of the various embodiments are set forth with particularity in the appended claims. The various embodiments, however, both as to organization and methods of operation, together with advantages thereof, may best be understood by reference to the following description, taken in conjunction with the accompanying drawings as follows:

FIGS. 1A-1C illustrate one embodiment of a symmetric waveguide structure.

FIGS. 2A-2B illustrate the interaction between an input radiofrequency wave and an input electron beam in the symmetric waveguide structure of FIGS. 1A-1C.

FIG. 3A illustrates one embodiment of an asymmetric slow wave structure.

FIG. 3B illustrates one embodiment of an asymmetric cell.

FIGS. 4A-4B illustrate an interaction between an input radiofrequency wave and an input electron beam in the asymmetric slow wave structure of FIG. 3A.

FIG. 5 illustrates one embodiment of a symmetric helical waveguide structure.

FIG. 6 illustrates one embodiment of a dispersion relation of the symmetric helical waveguide structure of FIG. 5.

FIG. 7 illustrates one embodiment of an asymmetric helical waveguide structure.

FIG. 8A illustrates one embodiment of a dispersion relation of the asymmetric helical waveguide structure of FIG. 7.

FIG. 8B illustrates one embodiment of phase velocity and frequency relationship of the asymmetric helical waveguide structure of FIG. 7.

FIG. 9 illustrates the impedance and frequency relationship of the asymmetric helical waveguide structure of FIG. 7.

FIG. 10 illustrates one embodiment of an asymmetric helical waveguide structure comprising a plurality of vanes.

FIG. 11 illustrates one embodiment of an asymmetrical ring-bar waveguide structure.

FIG. 12 illustrates one embodiment of a dispersion relation of the asymmetrical ring-bar waveguide structure of FIG. 11

FIG. 13 illustrates one embodiment of an asymmetrical coupled-cavity waveguide structure.

FIG. 14A illustrates one embodiment of an asymmetrical folded waveguide structure.

FIG. 14B illustrates one embodiment of an asymmetrical cell of the folded waveguide structure of FIG. 14A.

FIG. 15 illustrates one embodiment of a dispersion relation of the asymmetrical folded waveguide structure of FIG. 14A.

### DESCRIPTION

In various embodiments, a traveling wave amplifier circuit is disclosed. The traveling wave amplifier circuit is configured to receive an RF wave and an electron beam. The traveling wave amplifier effects synchronized interaction between the RF wave and the electron beam. The traveling wave amplifier circuit comprises a waveguide. The waveguide comprises a plurality of asymmetric cells arranged periodically. The waveguide is configured to receive an electron beam. The waveguide affects interaction between the RF input way and the electron beam. Each of the asymmetric cells comprises at least one asymmetrical structure within the asymmetric cell to modify the dispersion relation of the waveguide.

In various embodiments, a traveling wave tube amplifier is disclosed. The traveling wave tube amplifier comprises a waveguide. The waveguide comprises a plurality of asymmetric cells arranged periodically. The waveguide is configured to receive an electron beam. Each asymmetric cell comprises at least one asymmetrical structure within the asymmetric cell to modify the dispersion relation of the waveguide. The modified dispersion relation prevents backward-wave oscillation in the waveguide. The traveling wave tube amplifier further comprises an electron beam input device configured to generate the electron beam in the waveguide. The waveguide is configured to slow a wave velocity of an input radiofrequency beam to match an input velocity of the electron beam.

Reference will now be made in detail to several embodiments, including embodiments showing example implementations of asymmetrical slow wave structures. Wherever practicable similar or like reference numbers may be used in the figures and may indicate similar or like functionality. The figures depict example embodiments of the disclosed systems and/or methods of use for purposes of illustration only. One skilled in the art will readily recognize from the following description that alternative example embodiments of the structures and methods illustrated herein may be employed without departing from the principles described herein.

FIGS. 1A-1C illustrate one embodiment of a symmetrical slow wave structure (SWS). FIG. 1A illustrates a plurality of symmetric cells 110 arranged along axis X. FIG. 1B is a perspective cut-away side view of one embodiment of an electron sheet beam amplifier circuit, shown along axes X, Y, and Z. The circuit may comprises a slow wave structure (SWS), such as a symmetric waveguide 100, for slowing the wave velocity of an input radiofrequency (RF) wave to match the wave velocity of an input electron beam, such as, for example, the input electron sheet beam 102. The electron sheet beam 102 may be generated using any suitable sheet beam electron gun, for example. Synchronous interaction between the velocity-matched RF wave and the electron beam 102 affects a transfer of energy from the electron beam 102 to the RF wave, thus increasing the power of the input RF wave. The waveguide 100 may comprise a plurality of periodic cells 110. FIG. 1C illustrates one embodiment of a cell 110 of the waveguide 100. Each periodic cell 110 comprises a set of first projections 130 extending from the first wall 135 and a second projection 140 extending from the second wall 145. The second projection 140 is located symmetrically between the pair of first projections 130. The first projections 130 and the second projections 140 may comprise, for example, a metal material, a dielectric material, or a combination of metal and dielectric materials. U.S. Pat. No. 8,179,045, entitled “Slow Wave Structure Having Offset Projections Comprised of a Metal-Dielectric Composite Stack,” issued on May 15, 2012, is hereby incorporated by reference in its entirety.

The symmetric waveguide 100 may comprise multiple modes, such as a first, or fundamental, mode and a second mode. Each mode may comprise one or more forward-wave segments and one or more backward-wave segments. During a forward-wave segment, an input RF wave travels along the axis of propagation in the direction shown by arrow 120 and is complimentary to the electron beam 102. During a backward-wave segment, a reflected RF wave is traveling in the opposite direction of arrow 120. In a symmetrical waveguide structure, such as waveguide 100, the backward-wave segment of higher modes, for example, the backward-wave segment of the second mode, may intersect the electron beam 102. The second made may be referred to as a backward-wave mode due to the interaction between the second mode's backward-wave segment and the electron beam 102. The interaction between a backward wave and the electron beam 102 causes backward-wave oscillation in the symmetrical waveguide 100. The backward-wave oscillation effectively limits the usable amplification and the usable bandwidth of the waveguide 100.

FIG. 2A illustrates a phase velocity relationship of a forward wave 204 and a backward wave 206 of the symmetrical waveguide 100. The forward wave 204 and the backward wave 206 may intersect. For example, in the illustrated embodiment, the forward wave 204 and the backward wave 206 intersect at a frequency of 265 GHz. The intersection point may be referred to as the pi point. The pi point may correspond to the frequency at which the backward wave 206 begins to develop. Near the intersection point, both the forward wave 204 and the backward wave 206 interact with the electron beam 202. The interaction between the electron beam 202 and the backward wave 206 causes the backward wave 206 to be amplified and creates backward-wave oscillation in the waveguide 100. The backward-wave oscillation effectively limits the bandwidth of the waveguide 100. FIG. 2B illustrates a dispersion relation between the electron beam 202, a first mode 204, and a second mode 206 in the waveguide 100. As can be seen in FIG. 2B, the first mode 208 and the second mode 210 overlap, for example, at the pi point of 265 GHz. To the left of the pi point, the first mode 208 is still in a forward-wave segment. The first mode's 208 backward-wave segment, which develops when the circuit wave number times the length of the cell divided by pi is greater than three, does not interact with the electron beam 202. However, to the left of the pi point, the second mode's 210 backward-wave segment has already developed and interacts with the electron beam 202. Due to the interaction between the electron beam 202 and the backward-wave segment of the second mode 210, the waveguide 100 will experience backward-wave oscillation. The backward-wave oscillation limits the input bandwidth of the waveguide 100. The symmetric waveguide 100 has a theoretical bandwidth of about 23%. However, the backward-wave oscillation causes the bandwidth of the symmetric waveguide 100 to be reduced from a theoretical bandwidth of about 23% to a practical bandwidth of about 3%.

FIG. 3A illustrates an asymmetric slow wave structure. The asymmetric waveguide 300 comprises a plurality of asymmetric cells 310. FIG. 3B illustrates one embodiment of an asymmetrical cell 310 of the asymmetric waveguide 300. The asymmetric cell 310 may comprise a pair of first projections 330a, 330b extending from a first wall 335 and a second projection 340 extending from a second wall 345. The first projections 330a, 330b may be separated by a distance d. The second projection 340 may be located asymmetrically between the pair of first projections 330a, 330b. For example, in the illustrated embodiment, the center point of the second projection 340 is located at a distance of d/2+∈ from the first of the pair of first projections 330a and at a distance of d/2−∈ from the second of the pair of first projections 330b, wherein ∈ is a non-zero offset of the second projection 340. The asymmetric waveguide 300 may be generated by arranging a plurality of asymmetric cells 310 periodically. The asymmetric waveguide 300 may be configured to receive an input electron beam 302 and an input RF wave. The input RF wave may comprise a pure transverse-magnetic (TM) field or a combination of a transverse-magnetic (TM) field and a transverse-electric (TE) field.

In some embodiments, by breaking the symmetry of each individual cell 310 in the asymmetric waveguide 300, an RF reflection may be generated by each asymmetric cell 310. As a result of the large number of asymmetric cells 310 in an asymmetric slow wave structure, such as the asymmetric waveguide 300, for example, a high reflectance may be achieved over a given frequency band, even where the signal reflection from an individual asymmetric cell 310 may be very small. In some embodiments, the high reflectance generated in the asymmetric waveguide 300 creates a forbidden propagation frequency gap, or band-gap, in the asymmetric waveguide's 300 dispersion relation. In a symmetric slow wave structure, such as, for example, the symmetric waveguide 100 shown in FIGS. 1A-1C, the backward-wave segment of the higher order modes, such as, for example, the second mode 210, generates backward-wave oscillation due to interaction between the backward-wave segment and the electron beam, especially near the pi point. In an asymmetric slow wave structure, such as asymmetric waveguide 300, for example, the electron beam only interacts with the forward-wave segment of the second mode. The asymmetric waveguide 300 comprises a modified dispersion relation having a band-gap at the pi point which prevents interaction between the electron beam 302 and the backward-wave segment of the second mode. Because there is no interaction between the backward-wave segment and the electron beam 302, the backward-wave is not amplified, and backward-wave oscillation does not occur in the asymmetric slow wave structure.

FIG. 4A illustrates a phase velocity relationship of a forward wave 404 and a backward wave 406 of an asymmetric waveguide 300. As can be seen in FIG. 4A the forward wave 404 intersects the electron beam 402 for almost the entire bandwidth of the forward wave. The plurality of asymmetric cells 310 creates a band-gap between the forward wave 404 and the backward wave 406 of the asymmetric waveguide 300 at the pi point. The backward wave 406 of the asymmetric waveguide 300 lacks a phase velocity component that intersects with the electron beam 402. Therefore, the backward wave 406 is not amplified by the electron beam 402 and backward-wave oscillation does not occur in the asymmetric waveguide 300.

FIG. 4B illustrates a dispersion relation between the first mode 408 and the second mode 410 of the asymmetric waveguide 300. As can be seen in FIG. 4B, the first mode 408 of the asymmetric waveguide 300 is substantially similar to the first mode 208 of the symmetrical waveguide 100. The forward-wave segment of the first mode 408 interacts with the electron beam 402 over substantially the whole bandwidth of the forward-wave segment. The backward-wave segment of the first mode 408 does not interact with the electron beam 402. In some embodiments, the asymmetric waveguide 300 may comprise a band-gap between the first mode 408 and the second mode 410. The band-gap may be generated by RF reflection in a plurality of asymmetric cells 310. The band-gap may be generated at the pi point between the first mode 408 and the second mode 410. Unlike in the symmetrical waveguide 100, the backward-wave segment of the second mode 410 does not interact with the electron beam 402. Due to the band-gap, the only interaction between the second mode 410 and the electron beam 402 occurs in the forward-wave segment of the second mode 410. There is no interaction between a backward wave and the electron beam 402, and therefore amplification of a backward wave does not occur. By eliminating amplification of the backward wave, the asymmetric waveguide 300 does not experience backward wave-oscillation. The asymmetric waveguide 300 may have a theoretical bandwidth substantially equally to the theoretical bandwidth of the symmetric waveguide 100, about 23%. The asymmetric waveguide 300 may maintain the same first mode impedance as the symmetric waveguide 100. However, because the asymmetric waveguide 300 generates a band-gap of forbidden propagation frequencies, the backward-wave segment of the second mode 410 does not have a phase velocity component synchronous with the electron beam 402 and therefore is not amplified by the electron beam 402. Because the backward-wave segment of the second mode 410 does not interact with the electron beam 402, backward-wave oscillation does not occur in the asymmetric waveguide 300 and the asymmetric waveguide 300 may function substantially at the theoretical bandwidth, about 23%.

In some embodiments, an asymmetric slow wave structure, such as, for example, the asymmetric waveguide 300, may comprise a plurality of asymmetric cells comprising two asymmetric substructures comprising different phase velocities Vₚ₁ and Vₚ₂, such as, for example, a plurality of asymmetrical cells 310. The asymmetric cells may receive an input RF wave, such as, for example, a transverse-magnetic field input RF wave. The radial frequency to circuit wave number curve (ω−β) of the slow wave structure may be given by the equation:

$$cos ( β * {L}_{p} ) = cos ( {β}_{1} * {a}_{1} ) * cos ( {β}_{2} * {a}_{2} ) - 0.5 * [ \frac{{V}_{p 1}}{{V}_{p 2}} + \frac{{V}_{p 2}}{{V}_{p 1}} ] * sin ( {β}_{1} * {a}_{1} ) * sin ( {β}_{2} * {a}_{2} ) \qquad ( 1 )$$

wherein Lₚ is the period length of the slow wave structure, aⱼ (j=1, 2) is the substructure length of the asymmetric structure such that a₁+a₂=Lₚ, β is the circuit wave number, and Vₚⱼ (j=1, 2) is the phase velocity of the electromagnetic frequency, f, in each sub-cell such that:

$$\begin{matrix}{β}_{j} = \frac{ω}{{V}_{pj}} ( j = 1 , 2 ) ; and & ( 2 ) \\ ω = 2 π f & ( 3 )\end{matrix}$$

A band-gap in the dispersion relation of equation (1) will occur wherever the right-hand side of the equation (1) exceeds 1. The first band-gap will therefore exist at:

β*Lₚ=π±i*x i=\sqrt{−1} (4)

The maximum band-gap frequency will be achieved at:

$${β}_{1} * {a}_{1} = {β}_{2} * {a}_{2} = \frac{π}{2} \qquad ( 5 )$$

In this case:

$$x = ln ( \vert \frac{{V}_{p 2}}{{V}_{p 1}} \vert ) \qquad ( 6 )$$

Where ω₀ is the center frequency of the band-gap, the band-gap frequencies may be express as the equation:

$${Δω}_{gap} = {ω}_{0} * 4 * {sin}^{- 1} ( \frac{\vert {V}_{p 2} - {V}_{p 1} \vert}{{V}_{p 1} + {V}_{p 2}} ) / π \qquad ( 7 )$$

which for small variations in phase velocities, ΔVₚ, the frequency gap can be approximated by:

$${Δω}_{gap} = {ω}_{0} * \frac{2}{π} * \frac{Δ {V}_{p}}{{V}_{p}} \qquad ( 8 )$$

As can be seen in equation (8), even a small asymmetry in the individual cells of the slow wave structure creating two sub-cells with different phase velocities may generate a band-gap of forbidden frequencies for the asymmetric slow wave structure. The first order of the forbidden frequency gap is linear with the difference between the two phase velocities. Although the band-gap has been discussed with reference to the asymmetric waveguide 300, a transverse-magnetic field RF wave input and a two-substructure asymmetric cell, those skilled in the art will recognize that a band-gap may be similarly created in any slow wave structure comprising a periodic plurality of asymmetric cells. The asymmetric cells may comprise two or more asymmetric substructures. The asymmetric slow wave structure may be configured to receive a transverse magnetic field and/or a combination transverse magnetic field and transverse-electric field RF wave inputs For example, a band-gap may be created in asymmetric slow wave structures configured to receive an input electron beam, such as, for example, an electron beam.

In some embodiments, the use of an asymmetric slow wave structure, such as the asymmetric waveguide 300, for example, may allow the size of the slow wave structure to be reduced as compared to a symmetric slow wave structure, such as the symmetric waveguide 100, configured for use in comparable frequency ranges. In symmetric slow wave structures it may be necessary to add attenuation sections to the slow wave structure to cause attenuation of the backward wave in an attempt to limit backward-wave oscillation. However, the attenuation sections also affect forward wave amplification, and therefore additional symmetric cells must be added to compensate for the loss of power in the forward wave. The additional symmetric cells may necessitate additional attenuation sections. The feedback loop created between adding attenuation sections and compensating amplification sections may result in extremely large slow wave structures. In contrast, attenuation sections are not required in asymmetric slow wave structures, as backward wave oscillation does not occur in the asymmetric slow wave structures. Therefore, a smaller asymmetric slow wave structure may provide equivalent, or better, amplification than a larger symmetrical slow wave structure comprising multiple attenuation sections.

FIG. 5 illustrates one embodiment of a symmetrical helical waveguide 500 configured to receive an electron beam. The symmetrical helical waveguide 500 comprises a plurality of symmetrical cells 510 arranged periodically along the length of the symmetrical helical waveguide 500. The symmetrical cells 510 are symmetrical along each of a pitch, an azimuth, and a radius. The symmetrical helical waveguide 500 receives an RF input wave and slows the RF input wave to match the electron beam. The symmetrical helical waveguide 500 comprises a forward-wave segment during which the input RF wave and the electron beam are traveling in the same direction along the axis of propagation. The symmetrical helical waveguide 500 comprises a backward-wave segment during which a reflected RF wave is traveling in the opposite direction of the axis of propagation of the electron beam.

FIG. 6 illustrates a dispersion relation of the symmetrical helical waveguide 500. As can be seen in FIG. 6, the forward-wave segment of the first mode 608 and the backward-wave segment of the second mode 610 both intersect with the electron beam 602. In the symmetrical helical waveguide 500, the backward wave may comprise a phase velocity that intersects with the electron beam 602 and causes amplification of the backward wave. Amplification of the backward wave results in backward-wave oscillation of the symmetrical helical waveguide 500. The backward wave oscillation reduces the bandwidth of the symmetrical helical waveguide 500 similar to the reduction in bandwidth discussed above with respect to symmetrical waveguide 100.

FIG. 7 illustrates one embodiment of an asymmetrical helical waveguide 700. The asymmetric helical waveguide 700 comprises a plurality of asymmetrical helical cells 710 disposed periodically along the length of the asymmetrical helical waveguide 700. The asymmetrical cells 710 comprise a pitch, an azimuth, and a radius. At least one of the pitch, the azimuth, and/or the radius may vary within the asymmetric cell 710. For example, in the embodiment illustrated in FIG. 7, the asymmetrical cells 710 comprise a pitch angle that varies over the period of each asymmetric cell 710. In some embodiments, the pitch, the azimuth and/or the radius of the helix may be varied over the length of the asymmetrical cell 710.

FIG. 8A shows one embodiment of a phase velocity of a forward wave 804 and a backward wave 806 within the asymmetrical helical waveguide 700. As can be seen in FIG. 8A, a large band-gap exists between the forward wave 804 and the backward wave 806. The forward wave 804 comprises a phase velocity component that coincides with an electron beam 802 received by the asymmetric helical waveguide 700. The band-gap between the forward wave 804 and the backward wave 806 prevents the backward wave 806 from interacting with the electron beam 802 and prevents backward-wave oscillation in the asymmetric helical waveguide 700.

FIG. 8B shows one embodiment of the dispersion relation of the asymmetrical helical waveguide 700. As can be seen in FIG. 8B, the forward wave segment of the first mode 808 intersects the electron beam 802 over substantially the entire bandwidth of the forward wave segment. The backward wave segment of the first mode 808 does not intersect the electron beam 802. The asymmetrical helical waveguide 700 comprises a band-gap between the first mode 808 and the second mode 810. As a result of the band-gap, the backward wave segment of the second mode 810 does not comprise a phase velocity component that interacts with the electron beam 802. The only interaction between the second mode 810 and the electron beam 802 occurs in the forward-wave segment of the second mode 808. By creating a band-gap between the first mode 808 and the second mode 810, the asymmetrical helical waveguide 700 allows a wider bandwidth of the first mode 808 to be used, as backward-wave oscillation does not occur and therefore does not limit the bandwidth of the first mode 808. As with the asymmetric waveguide 300 discussed above with respect to FIGS. 3A-4B, the asymmetrical helical waveguide 700 has the same theoretical bandwidth as the symmetrical helical waveguide 500. However, because the asymmetrical helical waveguide 700 does not produce backward-wave oscillation, the asymmetrical helical waveguide 700 is able to use a larger portion of the theoretical bandwidth of the slow wave structure. In contrast, the symmetrical helical waveguide 500 is limited to a fraction of the theoretical bandwidth. In some embodiments, the asymmetric helical waveguide 700 may have a useable bandwidth of about three times the useable bandwidth of the symmetric helical waveguide 500, for example. FIG. 9 illustrates one embodiment of an impedance response 812 of the asymmetric helical waveguide 700. The impedance is plotted versus the scaled frequency of the input RF wave. The impedance response 812 of the first mode of the asymmetrical helical waveguide 700 is substantially similar to the impedance response of the first mode of the symmetrical helical waveguide 500 accept at the pi point.

In some embodiments, the input electron beam, for example the electron beam 802, may comprise, for example, an elliptical electron beam, a circular electron beam, and/or a hollow electron beam. The electron beam may comprise a plurality of electron beams. The plurality of electron beams may be generated by a plurality of electron guns. The plurality of electron beams may comprise a plurality of elliptical electron beams, circular electron beams, hollow electron beams, sheet electron beams, or any combination thereof.

In one embodiment, the asymmetrical helical waveguide 700 may comprise a discontinuous helical structure. For example, the asymmetrical helical waveguide 700 may comprise a periodic plurality of cells comprising a first pitch at a first angle and a second pitch at a second angle. The first and second pitches may be discontinuous. A discontinuous helix may be generated by any suitable manufacturing technique, such as, for example, electro-discharge machining (EMD). The discontinuous pitches may modify the dispersion relation of the discontinuous helical waveguide.

FIG. 10 illustrates one embodiment of an asymmetrical slow-wave-structure 901. The asymmetrical slow-wave-structure 900 comprises a helical waveguide 900 and a plurality of vanes 930. The plurality of vanes may extend from a housing 935 circumferentially located with respect to the helical waveguide 900. In various embodiments, the helical waveguide 900 and/or the plurality of vanes 930 may be asymmetric. For example, the helical waveguide 900 may be an asymmetric helical waveguide comprising a plurality of asymmetric cells, such as, for example, the asymmetric helical waveguide 700 shown in FIG. 7. As another example, the plurality of vanes 930 may be asymmetrically arranged about the circumference of the housing 935, such that the distance between the first vane 930a and the second vane 930b and the distance between the first vane 930a and the third vane 930c are not equal. In some embodiments, the asymmetric slow-wave-structure 901 may comprise an asymmetric helical waveguide 900 and an asymmetrical plurality of vanes 930a-c.

FIG. 11 illustrates one embodiment of an asymmetric ring-bar waveguide 1000. The asymmetric ring-bar waveguide 1000 is configured to receive an input electron beam and an input RF wave. The asymmetric ring-bar waveguide 1000 is configured to generate an interaction between the electron beam and the input RF wave to amplify the input RF wave. The asymmetric ring-bar waveguide 1000 may comprise a periodic plurality of asymmetric cells 1010. The asymmetric cells 1010 may comprise a first ring 1030, a second ring 1040, a first bar 1035a, a second bar 1045, and a third bar 1035b. The asymmetric cells 1010 may comprise one or more asymmetric structures, such as, for example, asymmetric widths of the first ring 1030 and the second ring 1040, asymmetric radii of the first ring 1030 and the second ring 1040, or asymmetric lengths of the first bar 1035a, the second bar 1045, and/or the third bar 1035b. For example, in the illustrated embodiment, the first ring 1030 comprises a first width and the second ring 1040 comprises a second width thinner than the first width.

FIG. 12 illustrates the dispersion relation of the asymmetric ring-bar waveguide 1000 shown in FIG. 11. The forward-wave segment of the first mode 1108 interacts with the electron beam input into the asymmetric ring-bar waveguide 1000. The backward-wave segment of the first mode 1108 does not interact with the electron beam. The asymmetry of each cell 1010 in the asymmetric ring-bar waveguide 1000 generates a band-gap at the pi point between the first mode 1108 and the second mode 1110 of the asymmetric ring-bar waveguide 1000. The band gap prevents interaction between the backward-wave segment of the second mode 1110 and the electron beam as the backward-wave segment lacks a phase velocity component synchronous with the electron beam phase velocity. Because the band-gap eliminates interaction between the backward-wave segment of the second mode 1110 and the electron beam, the asymmetric ring-bar waveguide 1000 does not produce backward-wave oscillation.

FIG. 13 illustrates on embodiment of an asymmetric coupled-cavity waveguide 1200 configured to receive an input electron beam and an input RF wave. The asymmetric coupled-cavity waveguide 1200 comprises a plurality of asymmetrical cells 1210. The asymmetric cells 1210 comprise end walls 1235a, 1235b and a middle wall 1245. The end walls 1235a, 1235b and the middle wall 1245 define one or more resonant cavities 1230, 1240 therebetween. The distance between the first end wall 1235a and the middle wall 1245 and the distance between the middle wall 1245 and second end wall 1235b may selected such that the one or more resonant cavities 1230, 1240 are asymmetric. The asymmetric resonant cavities 1230, 1240 generate a band-gap between the first mode and the second mod of the asymmetric coupled-cavity waveguide 1200. The band-gap prevents interaction between the backward-wave segment of the second mode and the input electron beam. Because the backward-wave segment and the electron beam do not interact, the asymmetric coupled-cavity waveguide 1200 does not experience backward-wave oscillation.

FIG. 14A illustrates one embodiment of an asymmetric folded waveguide 1300. The asymmetric folded waveguide 1300 is similar to the asymmetric waveguide 300 described above. The asymmetric folded waveguide 1300 comprises a plurality of asymmetric cells 1310. FIG. 14B illustrates one embodiment of a asymmetric cell 1310 of the asymmetric folded waveguide 1300. In some embodiments, the asymmetric cell may comprise a first wall 1335 and a second wall 1345. The distance between the first wall 1335 and the second wall 1345 may vary asymmetrically over the length of the asymmetric cell 1310. In one embodiment, the asymmetric folded waveguide 1300 may comprise one or more folds. The one or more folds may be any angle, for example, between 0° and 180°. In one embodiment, asymmetric folded waveguide structure may comprise one or more asymmetric folds.

FIG. 15 illustrates one embodiment of the dispersion relation of the asymmetric folded waveguide 1300. The forward-wave segment of the first mode 1408 interacts with the electron beam 1302 input into the asymmetric folded waveguide 1300. The backward-wave segment of the first mode 1408 does not interact with the electron beam. The asymmetry of each cell 1310 in the asymmetric folded waveguide 1300 generates a band-gap at near the pi point between the first mode 1408 and the second mode 1410 of the asymmetric folded waveguide 1300. The band gap prevents interaction between the backward-wave segment of the second mode 1410 and the electron beam as the backward-wave segment lacks a phase velocity component synchronous with the electron beam phase velocity. Because the band-gap eliminates interaction between the backward-wave segment of the second mode 1410 and the electron beam, the asymmetric folded waveguide 1300 does not produce backward-wave oscillation.

It is worthy to note that any reference to “one aspect,” “an aspect,” “one embodiment,” or “an embodiment” means that a particular feature, structure, or characteristic described in connection with the aspect is included in at least one aspect. Thus, appearances of the phrases “in one aspect,” “in an aspect,” “in one embodiment,” or “in an embodiment” in various places throughout the specification are not necessarily all referring to the same aspect. Furthermore, the particular features, structures or characteristics may be combined in any suitable manner in one or more aspects.

Some aspects may be described using the expression “coupled” and “connected” along with their derivatives. It should be understood that these terms are not intended as synonyms for each other. For example, some aspects may be described using the term “connected” to indicate that two or more elements are in direct physical or electrical contact with each other. In another example, some aspects may be described using the term “coupled” to indicate that two or more elements are in direct physical or electrical contact. The term “coupled,” however, also may mean that two or more elements are not in direct contact with each other, but yet still co-operate or interact with each other.

Although various embodiments have been described herein, many modifications, variations, substitutions, changes, and equivalents to those embodiments may be implemented and will occur to those skilled in the art. Also, where materials are disclosed for certain components, other materials may be used. It is therefore to be understood that the foregoing description and the appended claims are intended to cover all such modifications and variations as falling within the scope of the disclosed embodiments. The following claims are intended to cover all such modification and variations.

All of the above-mentioned U.S. patents, U.S. patent application publications, U.S. patent applications, foreign patents, foreign patent applications, non-patent publications referred to in this specification and/or listed in any Application Data Sheet, or any other disclosure material are incorporated herein by reference, to the extent not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

In some instances, one or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

Although various embodiments have been described herein, many modifications, variations, substitutions, changes, and equivalents to those embodiments may be implemented and will occur to those skilled in the art. Also, where materials are disclosed for certain components, other materials may be used. It is therefore to be understood that the foregoing description and the appended claims are intended to cover all such modifications and variations as falling within the scope of the disclosed embodiments. The following claims are intended to cover all such modification and variations.

In summary, numerous benefits have been described which result from employing the concepts described herein. The foregoing description of the one or more embodiments has been presented for purposes of illustration and description. It is not intended to be exhaustive or limiting to the precise form disclosed. Modifications or variations are possible in light of the above teachings. The one or more embodiments were chosen and described in order to illustrate principles and practical application to thereby enable one of ordinary skill in the art to utilize the various embodiments and with various modifications as are suited to the particular use contemplated. It is intended that the claims submitted herewith define the overall scope.

What is claimed is:

1. A traveling wave amplifier circuit to receive an RF wave and an electron beam and to effect synchronized interaction therebetween, the circuit comprising:
a waveguide comprising a plurality of asymmetric cells arranged periodically, wherein the waveguide is configured to receive an electron beam, and wherein each asymmetric cell comprises at least one asymmetrical structure within the asymmetric cell to modify the dispersion relation of the waveguide.

2. The traveling wave amplifier circuit of claim 1, wherein the at least one asymmetrical structure comprises a dimension of the waveguide, wherein the dimension of the waveguide varies a symmetrically over each asymmetric cell.

3. The traveling wave amplifier circuit of claim 2, wherein the waveguide comprises:
a helical structure, wherein each of the plurality of asymmetric cells comprises:
a pitch angle;
an azimuth; and
a radius; and
wherein at least one of the pitch angle, the azimuth, and the radius varies asymmetrically.

4. The traveling wave amplifier circuit of claim 3, wherein each of the plurality of asymmetric cells comprises a plurality of vanes, wherein the plurality of vanes are arranged asymmetrically along the azimuth of the helical structure.

5. The traveling wave amplifier of circuit of claim 1, wherein the waveguide comprises:
a coupled-cavity structure, wherein each of the plurality of asymmetric cells comprises:
a first resonant cavity;
a second resonant cavity; and
a transmission line, wherein the first resonant cavity and the second resonant cavity are in signal communication through the transmission line, and wherein the first resonant cavity and the second resonant cavity are asymmetrical.

6. The traveling wave amplifier circuit of claim 1, wherein the waveguide comprises:
a ring-bar structure, wherein each of the plurality of asymmetric cells comprises:
a first ring having a first radius;
a second ring having a second radius;
a first bar coupling the first ring and the second ring;
a second bar extending from the first ring away from the second ring; and
a third bar extending from the second ring away from the first ring, wherein at least one of the first radius, the second radius, the first bar, the second bar, or the third bar varies asymmetrically.

7. The traveling wave amplifier circuit of claim 1, wherein the waveguide comprises:
a folded waveguide, wherein each of the plurality of asymmetric cells comprises:
a first wall and a second wall opposite the first wall, wherein the first wall and the second wall are connected to define an axis of propagation and a rectangular cross-section that is normal to the axis of propagation, and wherein the axis of propagation comprises at least one fold, wherein the fold causes a change in a direction of an axis of propagation of the folded waveguide;
a plurality of first projections located on and extending from an interior surface of the first wall, wherein the first projections are pitched in a direction of the axis of propagation;
a plurality of second projections located on and extending from an interior surface of the second wall, wherein the second projections are pitched in the direction of the axis of propagation;
wherein a number of the second projections are located on and extending from the interior surface of the second wall in a staggered configuration I the direction of the axis of propagation relative to a number of corresponding first projections located on and extending from the interior surface of the first wall; and
wherein each second projection of the staggered configuration asymmetrically opposes a pair of adjacent first projections located on the interior surface of the first wall.

8. The traveling wave amplifier circuit of claim 1, wherein the asymmetric structure comprises a plurality of vanes extending from an interior surface of the waveguide, wherein the plurality of vanes are arranged asymmetrically within each cell.

9. The traveling wave amplifier circuit of claim 8, wherein the plurality of vanes comprise a metal material.

10. The traveling wave amplifier circuit of claim 8, wherein the plurality of vanes comprise a composite stack of a dielectric material and a metal material.

11. The traveling wave amplifier circuit of claim 1, wherein the asymmetric structure comprises one or more dielectric rods metallically sputtered asymmetrically on an interior surface of the waveguide.

12. The traveling wave amplifier circuit of claim 1, wherein the electron beam comprises a plurality of electron beams.

13. The traveling wave amplifier circuit of claim 1, wherein the electron beam comprises a hollow electron beam.

14. The traveling wave amplifier circuit of claim 1, wherein the electron beam comprises a circular electron beam.

15. A traveling wave tube amplifier comprising:
a waveguide comprising a plurality of asymmetric cells arranged periodically, wherein the waveguide is configured to receive an electron beam, and wherein each asymmetric cell comprises at least one asymmetrical structure within the asymmetric cell to modify the dispersion relation of the waveguide;
an electron beam input device configured to generate an electron beam in the waveguide, wherein the waveguide is configured to slow a wave velocity of an input radiofrequency beam to match an input velocity of the electron beam, and wherein the asymmetrical structure is configured to eliminate the backward wave oscillation of the radiofrequency beam within the waveguide.

16. The traveling wave tube amplifier of claim 15, wherein the at least one asymmetrical structure comprises a dimension of the waveguide, wherein the dimension of the waveguide varies a symmetrically over each asymmetric cell.

17. The traveling wave tube amplifier of claim 16, wherein the waveguide comprises:
a helical structure, wherein each of the plurality of asymmetric cells comprises:
a pitch angle;
an azimuth; and
a radius; and
wherein at least one of the pitch angle, the azimuth, and the radius varies asymmetrically.

18. The traveling wave tube amplifier of claim 16, wherein the waveguide comprises:
a coupled-cavity structure, wherein each of the plurality of asymmetric cells comprises:
a first resonant cavity;
a second resonant cavity; and
a transmission line, wherein the first resonant cavity and the second resonant cavity are in signal communication through the transmission line, and wherein the first resonant cavity and the second resonant cavity are asymmetrical.

19. The traveling wave tube amplifier of claim 16, wherein the waveguide comprises:
a ring-bar structure, wherein each of the plurality of asymmetric cells comprises:
a first ring having a first radius;
a second ring having a second radius;
a first bar coupling the first ring and the second ring;
a second bar extending from the first ring away from the second ring; and
a third bar extending from the second ring away from the first ring, wherein at least one of the first radius, the second radius, the first bar, the second bar, or the third bar varies asymmetrically.

20. The traveling wave tube amplifier of claim 16, wherein the waveguide comprises:
a folded-waveguide, wherein each of the plurality of asymmetric cells comprises:
a first wall and a second wall opposite the first wall, wherein the first wall and the second wall are connected to define an axis of propagation and a rectangular cross-section that is normal to the axis of propagation, and wherein the axis of propagation comprises at least one fold, wherein the fold causes a change in a direction of an axis of propagation of the folded waveguide;
a plurality of first projections located on and extending from an interior surface of the first wall, wherein the first projections are pitched in a direction of the axis of propagation;
a plurality of second projections located on and extending from an interior surface of the second wall, wherein the second projections are pitched in the direction of the axis of propagation;
wherein a number of the second projections are located on and extending from the interior surface of the second wall in a staggered configuration I the direction of the axis of propagation relative to a number of corresponding first projections located on and extending from the interior surface of the first wall; and
wherein each second projection of the staggered configuration asymmetrically opposes a pair of adjacent first projections located on the interior surface of the first wall.
